(19) United States
(12) Patent Application Publication
(10) Pub. No.: US 2017/0349316 A1
(43) Pub. Date: Dec. 7, 2017

(54) Rollers For A Labelling Machine

(71) Applicant: Norton (Waterford) Limited, Waterford (IE)

(72) Inventor: Anthony Kirwan, Waterford (IE)

(73) Assignee: Norton (Waterford) Limited, Waterford (IE)

(21) Appl. No.: 15/536,843

(22) PCT Filed: Dec. 17, 2015
(86) PCT No.: PCT/EP2015/080210

§ 371 Date: Jun. 16, 2017

(30) Foreign Application Priority Data
Dec. 17, 2014 (GB) 1422497.6

(51) Int. Cl. B65C 9/04; B65C 3/00

(52) U.S. Cl. CPC B65C 9/04; B65C 3/00

(57) ABSTRACT

A carousel for a canister labelling machine comprising a plurality of roller shafts (7) circumferentially located around the carousel. Each roller shaft (7) has one end (8) adapted to be coupled to said carousel and a second end (13) adapted to receive a label roller (9) and further comprising a releasable fitting on a distal end thereof. The roller assembly consists of the outer roller shaft with two supporting bearings.

### BACKGROUND

The present invention is concerned with a labelling machine and to a particular label roller arrangement used with such a machine. The invention is particularly, but not exclusively, related to a labelling machine used to apply labels to medicament canisters such as metered dose inhaler (MDI) canisters.

Aerosol type canisters used in MDI's must be appropriately labelled according to local legal requirements. The labels must be very accurately aligned with no damage or creases which could prevent the user from being able to clearly read the information printed on the label.

This presents significant problems in machine design because of the strict requirements for accurate location of the labels. Furthermore, the speed with which the canister must be labelled adds further to the problems of labelling machine development and design.

In order to meet these requirements complicated conveying and labelling machines have been developed. These machines require high levels of maintenance to ensure that the production lines which fill and label MDI canisters are not disrupted.

The inventors of the present invention have devised an alternative labelling machine arrangement which meets the requirements of both accuracy and speed whilst simultaneously improving reliability, reducing maintenance costs and prolonging service life.

### SUMMARY

Viewed from a first aspect of an invention described herein there is provided a carousel for a canister labelling machine, said carousel comprising a plurality of roller shafts circumferentially located around the carousel, each roller shaft comprising a first end adapted to be coupled to said carousel and a second opposing end adapted to receive a label roller and further comprising a releasable fitting on a distal end thereof adapted to secure the roller onto said roller shaft, wherein the roller consists of a pair of bearings, each bearing being located at opposing ends of said roller and arranged to allow said roller to rotate with respect to the roller shaft.

Thus, a carousel arrangement is provided that utilises just one pair of bearings per roller. This in combination with the releasable fastening of the roller itself to the shaft (and thereby to the carousel) provides a number of synergistic advantages over existing and conventional labelling machinery.

Turning to the prior art, conventional labelling machines are configured so that roller assemblies are made up and then connected to the carousel. It is important that the roller assemblies are correctly aligned to ensure that each label is smoothly and accurately applied to the outer surface of the canister. Any misalignment or movement of the roller assemblies (other than rotation) can cause misalignment of labels or in a worst case scenario creasing or tearing of labels. This greatly increases downtime and product rejection and thereby increases costs.

Conventional labelling machines achieve the above requirements by ensuring that the rollers are securely coupled onto shafts which are then themselves securely connected to the machine. The rollers are supported by 4 evenly spaced bearings that allow the roller to rotate on the shaft. When maintenance is required the roller assembly is de-coupled from the labelling machine and maintenance to the assembly can be done.

The inventors have surprisingly found that an arrangement according to the aspect above actually enhances performance and reliability of the labelling process.

For example, it has been established that a single pair of bearings advantageously reduces the chance of bearing failure and prolongs service intervals. It was conventionally believed that a larger number of bearings would enhance reliability by reducing the load per bearing and spreading the support the bearings provides to the roller along the length of each roller. This would then enhance the operational life of the bearings.

However, the inventors have established that a single pair of bearings in combination with a particular construction of carousel allows even greater performance to be achieved.

For example, by providing a releasable fitting to one end of the roller shaft the opposing end of the shaft can be permanently (or more permanently) fixed to the carousel. By reducing the number of times the connection to the carousel is used the chances of misalignment being introduced can be reduced.

This has a number of advantages in itself including (and not limited to):
the chance of damaging the couplings between shaft and carousel is minimised
the chance of misalignment of adjacent rollers can be minimised thereby ensuring that adjacent rollers are always at the correct alignment.
maintaining the rollers becomes inherently less complicated since the releasable fitting allows the roller assembly to be conveniently removed for servicing
tooling for maintenance becomes simpler and more time efficient.
maintenance requires less training, thereby further reducing costs.

Thus, according to the invention the rigidity and accurate positioning of the shafts relative to one another can be preserved by providing an arrangement according to the present invention.

Furthermore, the single pair of bearings surprisingly improves operational life because bearing failure risk can be substantially reduced. This further reduces machinery downtime and enhances production. Bearing wear and/or failure can cause vibrations or ‘judder’ within the carousel causing other damage to the machine.

Still further, the roller itself can be inverted extremely quickly according to the invention and this conveniently doubles the life of the roller assembly by allowing the roller to be removed, inverted and repositioned on the roller shaft in minimal time.

Each roller shaft may comprise an abutment against which a bearing closest to the carousel is arranged to abut. Thus, the bearing closest to the carousel abuts with the abutment of the shaft thereby preventing the bearing, and the roller, from moving axially along the bearing. In an arrangement where the abutment is located above the roller it prevents the roller from moving vertically upwards or ‘riding up’ as it is known in the art. The ‘rising up’ problem disadvantageously causes sticking problems with the labels and again results in machinery downtime.

The abutment may be any suitable projection from the shaft to prevent axial movement of the roller. In order to circumferentially locate the bearing and provide a uniform restraining force on the abutment may advantageously be in the form of a portion of the length of the shaft having a larger diameter than the remainder of the length of the shaft (a ‘shoulder’). Thus the bearing is supported all around it circumference preventing twisting or misalignment.

So as to locate the roller on the shaft the roller itself may be provided with centrally located hole having a diameter slightly larger than a roller shaft to allow the roller to be positioned on and coaxially with a roller shaft.

The bearings supporting the roller and connecting the roller to the shaft may advantageously be located within a countersunk hole formed in each end of said roller. In effect a countersunk circular (cylindrical) recess is formed corresponding approximately to the outer diameter of the bearing and having a depth corresponding substantially to the width of the bearing. This means the bearing is axially located on one side by the bottom of the recess and circumferentially engages with the roller by contact around the side walls of the countersunk recess. This securely locates the bearing and fully supports the roller.

The inner race of each bearing may be coupled to the roller shaft by means of a push fit. This allows for simply assembly of the roller assembly within minimal tooling. Similarly the outer race of each bearing may be coupled to the roller by means of a push fit.

The diameter of the roller may be between 15 mm and 75 mm.

The roller may be made from Black Nylon or any other suitable material. In some examples the roller may be made from a metal and in other examples the roller is made from a polymer. The particular application of the roller is an important factor in the material choice.

The roller shaft may be coupled to the carousel by any suitable means. The coupling may be permanent such as by welding or may be releasable. For example, the shafts may be coupled to the carousel by means of a thread and locking nut. This could be considered to be a semi-permanent coupling as distinct from the releasable fastening on the opposing end of each shaft which allows for very fast release and maintenance.

The releasable fastening may be any suitable fastening that can securely locate the roller on the shaft at the speeds the carousel will travel. Advantageously the fastening may be in the form of a circumferential recess formed in the end of the roller shaft into which a spring loaded or sprung metal (or other) clip (often referred to as a circlip) may be located. The spring loading of the fastener ensures that the fastener is securely located within the recess and thereby prevents the roller from sliding off the bottom of the shaft.

A washer may be located between the fastener and the roller/bearing surface to prevent wear and damage occurring resulting from the relative movement of fastener and roller.

The bearings themselves may be advantageously provided with seals so as to retain a lubricant within the bearing housing. This advantageously prevents any lubricant from leaving the bearing and contaminating the labels and further prolongs the operational life of the bearing.

A roller, needle roller or ball bearing may advantageously be used. In some examples a standard ball bearing is used.

Advantageously the first end of each roller shaft may be located in an elevated position with respect to the second opposing end of the roller shaft. In combination with the abutment this prevents the roller from moving upwards (‘riding up’) as discussed above.

The carousel is advantageously arranged with pairs of adjacent roller shafts such that a canister, to which a label is to be applied, contacts and is supported by adjacent rollers, one on each side of the canister.

The circumferential spacing of roller shaft pairs may for example be every 35 mm. This is particularly suitable for use with metered dose inhalers that have a typical diameter range of 20 mm-23 mm. However this spacing may also be used in conjunction with larger diameter containers having a label applied in a similar rotational fashion.

Viewed from another aspect there is provided a canister labelling machine comprising a carousel as described herein.

In such a machine there may be provided 36 roller shafts positioned in pairs around the perimeter of the carousel.

Viewed from yet another aspect there is provided a canister labelling machine carousel, said carousel comprising a plurality of roller assemblies circumferentially located around the carousel, each roller assembly comprising a shaft and a label application roller rotatably mounted thereto, wherein a first end of said shaft is coupled to said carousel and a second end of said shaft comprises a releasable fastener permitting the label application roller to be selectively removed from said second end of said shaft.

Viewed from yet another aspect there is provided a canister labelling machine carousel, said carousel comprising a plurality of roller shafts circumferentially located around the carousel, each roller shaft having a label application roller mounted thereon, wherein the label application roller comprises a central passage arranged to receive the roller shaft and two countersunk portions each dimensioned to receive a bearing.

Viewed from a still further aspect there is provided a method of applying a label to a metered dose inhaler canister using a labelling apparatus comprising a carousel as described herein.

### BRIEF DESCRIPTION OF THE ACCOMPANYING FIGURES

Specific embodiments of the present invention will be described by way of example only and with reference to the accompanying figures in which:

FIG. 1 shows a conventional labelling machine label assembly;

FIG. 2 is a cross section through a conventional roller;

FIG. 3 shows a disassembled label assembly according to the present invention;

FIG. 4 shows a cross-section through a roller according to the present invention;

FIG. 5 shows a carousel according to the present invention;

FIG. 6 illustrates the sequence of building the roller assembly onto the carousel; and

FIG. 7 illustrates the flow of canisters into and around the carousel and a canister disposed between two adjacent roller assemblies.

While the invention is susceptible to various modifications and alternative forms, specific embodiments are shown by way of example in the drawings and are herein described in detail. It should be understood, however, that the drawings and detailed description of the specific embodiments are not intended to limit the invention to the particular forms disclosed. On the contrary, the invention is cover all modifications, equivalents and alternatives falling within the spirit and the scope of the present invention as defined by the appended claims.

### DETAILED DESCRIPTION

FIG. 1 shows a conventionally roller assembly for a labelling carousel.

The term ‘carousel’ is the term used in the art to describe the generally circular conveyor that collects canisters from a supply line (typically a conveyor belt or the like) and carries the canister past a labelling head (which applies the label to the outer surface of the canister) and to another output conveyor.

The carousel rotates about its central axis, collects canisters between adjacent rollers, passes the canister past a printing or label head and on to an output line (again typically a conveyor or belt). The circular nature of the carousel conveniently allows for high speed of movement of the canisters past the label head.

Returning to FIG. 1, a conventional assembly comprises a steel shaft 1 with a flanged lower end 2. The upper end of the shaft 1 is provided with a thread 3 which allows the shaft to be screwed into the carousel (not shown).

The conventional assembly is provided with a rubber roller 4 having a smooth outer surface for contact with a canister. Four open roller bearings 5a-5d are positioned onto the shaft 1 at equal intervals along its length and the roller is then passed over the top and abuts with the flange 2.

A washer arrangement 6 may be optionally used at either end of the roller.

Once the roller and bearing are in place over the shaft the roller assembly is ready to be secured to the carousel. This is done by screwing the thread 3 into a corresponding thread on the carousel. This is repeated all around the carousel until all the roller assemblies are secured and the carousel is then ready for mounting on the labelling machine and its rotatory drive which causes the carousel to rotate.

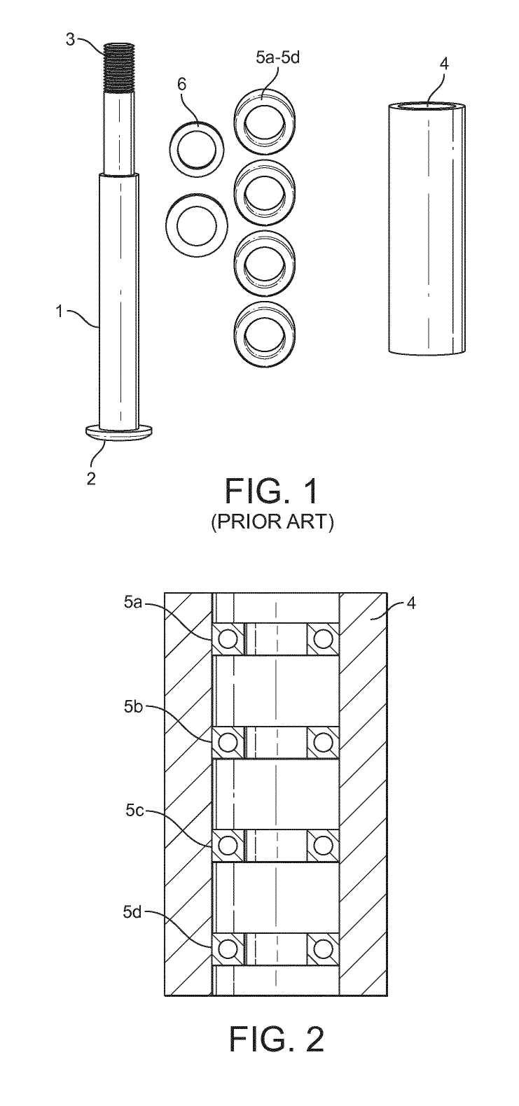

FIG. 2 is a cross section through the roller of a conventional labeller which the equal spacing of the 4 bearings 5a-5d is shown schematically. The hatching represents the side wall of the roller 4.

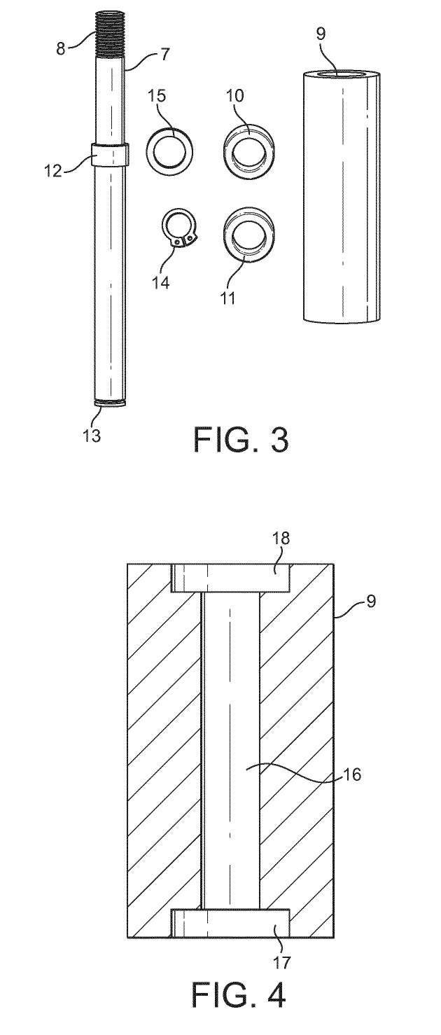

FIG. 3 shows the components of a roller assembly according to the present invention.

It will be immediately clear that the assembly is few in sub-components and is simpler in construction than the conventional arrangement. Counterintuitively the inventors have established that such a simplified and modified arrangement improves maintenance access as well as numerous other advantages including those discussed above.

The assembly comprises a roller shaft 7 having two opposing ends, each with a different fastener i.e. one end has a fastening that can be removed more quickly and conveniently than the other. The upper fastener 8 is a threaded portion which may be coupled to the carousel, for example, by screwing the thread into a corresponding threaded recess or by using a locking nut. This upper fastener 8 firmly couples the shaft to the carousel.

The assembly also comprises a label roller and importantly only two sealed bearings 10, 11.

Returning to the roller shaft 8, the shaft further comprises a shoulder or projection approximately ⅓rd of the way down the roller shaft (the precise location depending on the specific carousel).

The shoulder 12 is formed integrally with the shaft and specifically is a short length of the shaft with a diameter greater than the diameter of the rest of the length of the shaft. The function of the shoulder is explained below.

The lower end of the shaft incorporates a releasable fastener 13 is the form of a circumferentially extending groove or slot into which a spring loaded clip (a circlip) 14 can be selectively attached and removed. A circlip requires a particular tool to apply and remove from the circumferential groove but advantageously allows the fastener to be rapidly attached and removed from the shaft.

A conventional washer, such as a polytetrafluoroethylene (PTFE) washer 15, is also part of the assembly and will be described further below.

FIG. 4 is a cross-section through a roller according to the present invention.

As shown in cross-section (the hatched section indicating the roller wall). The roller 9 comprises an ‘I’ in cross-section i.e. a central passage 10 arranged to receive the roller shaft and two opposing countersunk portions 17, 18. Each countersunk portion 17, 18 is dimensioned to receive a bearing (not shown).

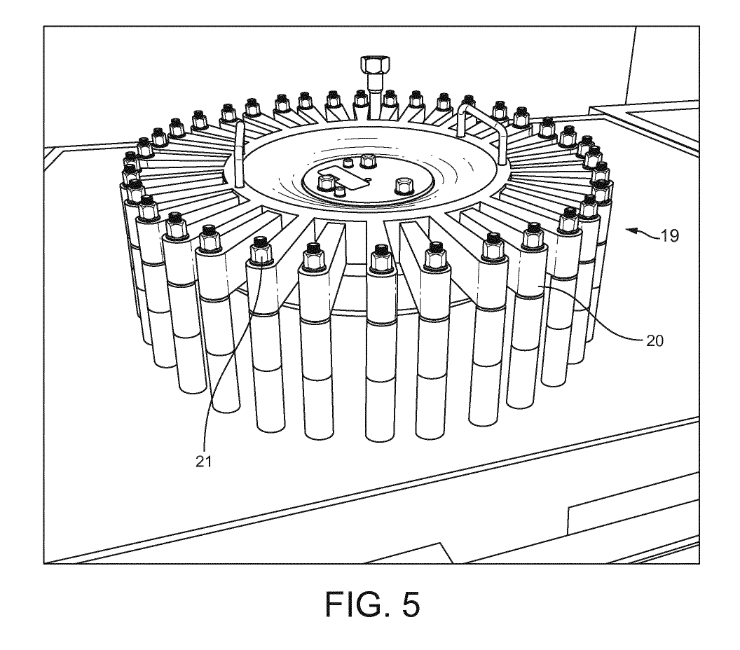

The steps of assembling the roller will now be described, first with reference to FIG. 5 which shows a complete carousel incorporating roller assemblies according to the present invention.

The carousel 19 is shown in FIG. 5 comprising a plurality of roller assemblies 20 arranged around the circumference of the carousel. As can be seen the roller assemblies are arranged in pairs so as to make contact with opposing side surfaces of a canister which (in use) is located between them.

Referring back to FIG. 3 the upper threaded portion 8 of the roller shaft 7 can be seen in FIG. 5 with a corresponding locking nut 21 firmly connecting the shaft 7 to the carousel 19.

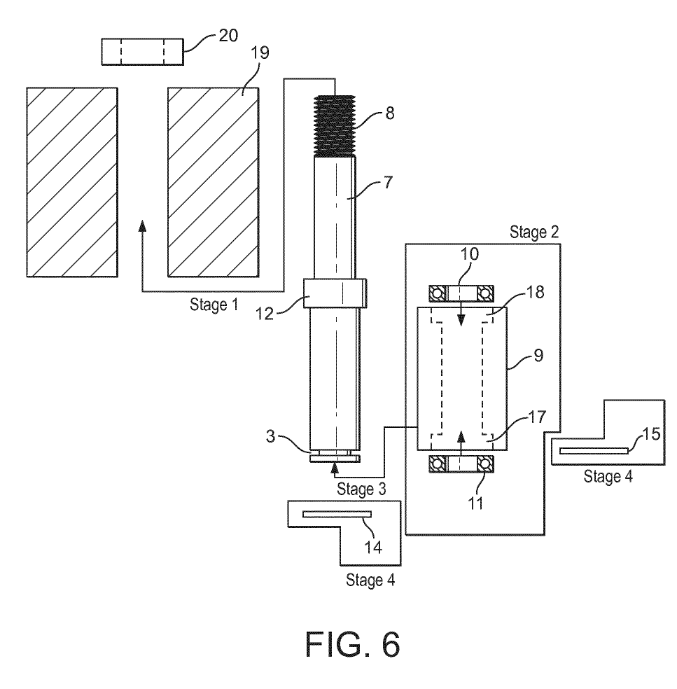

The stages of assembly will now be described with reference to FIG. 6.

### Stage 1—Roller Shaft/Carousel Assembly

The first step of assembling the roller assembly according to the invention is to attach the plurality of roller shafts to the carousel.

Referring to FIG. 6, the upper threaded portion 8 of the roller shaft 7 is inserted into the carousel body 19. The upper part of the shaft containing the thread protrudes from the upper surface of the body and a locking nut 20 is tightened to securely and firmly couple the shaft to the carousel body. According to the invention this upper locking nut fastening is, in effect, a semi-permanent fastening i.e. in principle it can be removed but in practice it is intended to remain connected to the carousel.

This is repeated around the 36 roller assemblies shown in FIG. 5.

In one arrangement the shafts could be integrated into the carousel body meaning that stage 1 may not be required where the carousel incorporates roller shafts.

### Stage 2—Roller/Roller Bearing Assembly

Stage 2 involves mounting the pair of bearings 10, 11 into the countersunk recesses 17, 18 on each end of the roller 9. The bearings and holes are selected so that a press fit can be used to locate the bearings into each end of the roller. The bearings are pre-sealed and contain a lubricant.

Stage 3—Mounting Roller onto Lower Shaft End

Stage 3 involves sliding the roller/roller bearing sub-assembly onto the lower end of the shaft and over the circumferential recess 3. The shoulder 12 is already in abutment with the lower surface of the carousel body 19 and the roller is pushed on to the lower end of the shaft until the upper bearing 10 abuts with the lower surface of the abutment 12. The bearing and abutment engage to locate the roller onto the shaft and to prevent any further upwards movement.

### Stage 4—Securing the Roller

Finally the roller is secured onto the shaft using a PTFE washer 15 and circlip 14. The roller is then secured to the shaft. The shoulder 12 prevents vertical movement in the upwards direction and the circlip 14 prevents vertical movement in the downwards direction. Thus, the roller is firmly secured to the shaft and the assembly is complete.

The roller assembly can be very conveniently maintained using the releasable fastening on the lower part of the assembly to replace the bearings or invert the roller.

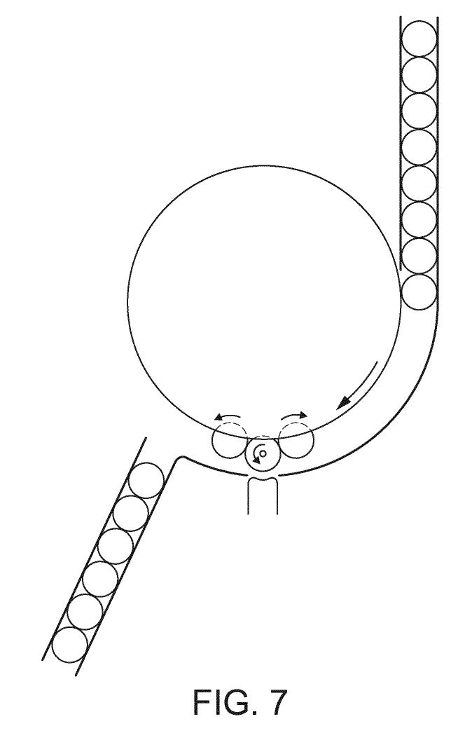

FIG. 7 illustrates the general movement of canisters through the labelling machine. As shown, canisters are delivered to the generally circular carousel at the top right of FIG. 7 via a delivery channel. This may be a simple channel where canisters abut one another in a line. Alternatively the end of the channel proximate the carousel may further comprise a worm gear having a pitch sized to accommodate a canister. Thus, as the worm drive rotates it can feed the canisters forwards and into the carousel.

The carousel rotates and transports each canister past the labelling head at the bottom of FIG. 7 where the label is applied. The labelled canisters then leave the labelling machine via a second channel shown at the lower left of FIG. 7.

It will be recognised that the aspects and features of the invention may be used in any suitable combination and that the application and invention is not limited just to the embodiments described herein.

1. A carousel for a canister labelling machine, said carousel comprising a roller and a plurality of roller shafts circumferentially located around the carousel, each roller shaft comprising:
a first end adapted to be coupled to said carousel; and
a second opposing end adapted to receive a roller and further comprising a releasable fitting on a distal end thereof adapted to secure the roller onto said roller shaft,
wherein the roller includes a pair of bearings, each bearing being located at opposing ends of said roller and arranged to allow said roller to rotate with respect to the roller shaft.

2. A carousel as claimed in claim 1, wherein each roller shaft comprises an abutment against which a bearing closest to the carousel is arranged to abut.

3. A carousel as claimed in claim 2, wherein the abutment is in the form of a portion of the length of the roller shaft having a larger diameter than the remainder of the length of the roller shaft.

4. A carousel as claimed in claim 1, wherein each roller comprises a centrally located hole having a diameter larger than the roller shaft to allow the roller to be positioned on and coaxially with the roller shaft.

5. A carousel as claimed in claim 1, wherein each bearing is located within a countersunk hole formed in an end of said roller.

6. A carousel as claimed in claim 5, wherein a depth of the countersunk hole extending into the roller corresponds substantially to a width of the bearing housing.

7. A carousel as claimed in claim 1, wherein an inner race of each bearing is coupled to the roller shaft by means of an interference fit.

8. A carousel as claimed in claim 1, wherein an outer race of each bearing is coupled to the roller by means of a push fit.

9. A carousel as claimed in claim 1, wherein the roller has an outer diameter of between 15 mm and 75 mm.

10. A carousel as claimed in claim 1, wherein the roller has an outer diameter of 20 mm.

11. A carousel as claimed in claim 1, wherein the first end of each roller shaft is adapted to be coupled to said carousel by means of a thread and nut.

12. A carousel as claimed in claim 1, wherein the releasable fitting on the distal end of each roller shaft is provided by use of a circlip.

13. A carousel as claimed in claim 12, wherein a washer is located between the releasable fitting and the bearing.

14. A carousel as claimed in claim 1, wherein each bearing is a sealed bearing and the seal is adapted to retain a lubricant within the bearing.

15. A carousel as claimed in claim 1, wherein the first end of each roller shaft is located in an elevated position with respect to the second opposing end of the roller shaft.

16. A carousel as claimed in claim 1, wherein the roller shafts are arranged in pairs to receive in use a canister therebetween.

17. A carousel as claimed in claim 16, wherein the roller shafts are arranged in pairs to receive a metered dose inhaler canister therebetween.

18. A carousel as claimed in claim 16, wherein the circumferential spacing of roller shaft pairs is every 35 mm.

19. A carousel as claimed in claim 1 wherein the roller is made of Black Nylon.

20. A canister labelling machine comprising a carousel as claimed in claim 1.

21. A canister labelling machine as claimed in claim 20, comprising 36 roller shafts.

22. A canister labelling machine carousel, said carousel comprising a plurality of roller assemblies circumferentially located around the carousel, each roller assembly comprising a shaft and a label application roller rotatably mounted thereto, wherein a first end of said shaft is coupled to said carousel and a second end of said shaft comprises a releasable fastener permitting the label application roller to be selectively removed from said second end of said shaft.

23. A carousel as claimed in claim 22, wherein the label application roller is rotatably mounted to the shaft by a pair of bearings, each bearing being located at opposing ends of said label application roller.

24. A canister labelling machine carousel, said carousel comprising a plurality of roller shafts circumferentially located around the carousel, each roller shaft having a label application roller mounted thereon,
wherein the label application roller comprises a central passage arranged to receive the roller shaft and two countersunk portions located at opposing ends of the label application roller, wherein each countersunk portion is dimensioned to receive a bearing.

25. A carousel as claimed in claim 24, wherein each roller shaft comprises a first end adapted to be coupled to said carousel; and a second opposing end adapted to secure the label application roller onto said roller shaft.

26. A carousel as claimed in claim 24, wherein the label application roller is rotatably mounted to the roller shaft by a pair of bearings, each bearing being located in a countersunk portion of the label application roller.

27. A method of applying a label to a metered dose inhaler canister with a labelling apparatus comprising a carousel according to claim 1.

28-29. (cancele
